(19) United States
(12) Patent Application Publication
(10) Pub. No.: US 2022/0009189 A1
(43) Pub. Date: Jan. 13, 2022

(54) PRESS PAD FOR SINGLE LEVEL OR MULTI-LEVEL HOT PRESS

(71) Applicant: HUECK RHEINISCHE GMBH, Viersen (DE)

(72) Inventors: Heinz-Willi Wolters, Duren (DE); Stanislav Sapasnik, Meerbusch (DE)

(21) Appl. No.: 17/390,992

(22) Filed: Aug. 1, 2021

Related U.S. Application Data
(63) Continuation of application No. PCT/EP2020/057217, filed on Mar. 17, 2020.

(30) Foreign Application Priority Data
Mar. 19, 2019 (DE) DE102019107005.8

(51) Int. Cl. B30B 15/06

(52) U.S. Cl. CPC B30B 15/061

(57) ABSTRACT

A press pad for a single level or multi-level hot press, the press pad comprising: a fabric made from two intersecting thread systems, wherein threads of a first thread system are respectively formed by a core thread and a cladding, wherein the cladding is made from an elastomer material and threads of a second thread system respectively include metal or are made from metal, wherein threads of the second thread system run in an alternating pattern over and under a group of adjacent threads of the first thread system wherein the group includes at least two directly adjacent and parallel threads, wherein groups that are separated from each other by at least one thread of the first thread system run on congruent paths or on paths that are displaced relative to each other in a thread longitudinal direction.

### RELATED APPLICATIONS

This application is a continuation of International application PCT/EP2020/057217 filed on Mar. 17, 2020 claiming priority from German Patent Application DE 10 2019 107 005.8 filed on Mar. 19, 2019, both of which are incorporated in their entirety by this reference.

### FIELD OF THE INVENTION

The invention relates to a press pad for a single level or multi-level hot press.

### BACKGROUND OF THE INVENTION

Wood material sheets like plywood, particle board, MDF, or HDF sheets, are coated with synthetic resin films in single level or multi-level hot presses that can be configured as low pressure or high pressure presses. Single level low pressure presses that operate at a specific pressing pressure of up to approximately 500 N/cm² at a high closing velocity are also designated as fast cycle presses. Fast cycle presses are used for example to coat flooring plates that are made from high density fiberboard with decorative melamine films or melamine resin overlays.

Producing the flooring material plates requires a uniform pressing pressure and a uniform and quick heat transfer. In order to fulfill these requirements the press pads used in the hot presses that are arranged as buffers between the product to be processed and the heating plates of the hot press have to provide sufficient cushioning in order to evenly distribute the pressing pressure of the hot press on the product and on the other hand side have good heat conductivity in order to provide quick heat transfer between the product to be pressed and the respective heating plate of the hot press.

Today press pads are being used that have reset properties that are mainly defined by the elastomer materials included therein. Relevant elastomer materials are silicon rubber, fluor silicon rubber, fluor rubber, as well as copolymers made from silicon and fluor silicon rubber. Press pads typically are textile products that are available in many embodiments with respect to materials and binding types.

The utility model DE 295 18 204 U1 describes a press pad which has a greater elastic expansion and a greater spring capability over a longer period of time compared to conventional press pads without sacrificing heat conductivity of the press pad. In order to comply with these requirements, the described press pad has two thread systems wherein a first thread system is formed from threads made from a metal wire enveloped by silicone whereas the second thread system includes metal threads. The fabric is provided with twill weave. Consequently, the press pad is provided with diagonally extending lines at the surfaces wherein the lines are formed by the metal threads.

WO 00/01522 A1 discloses a press pad where the heat conductivity of the press pad is to be improved by providing the warp threads and/or weft threads in a band shape, that means with a quasi-rectangular cross section. Also here the press pad has twill weave.

WO 2004/096534 A1 describes a press pad that has twill weave and that is impregnated with graphite particles. Additives of this type, however, are disadvantageous in that they increase a hardness of the elastomer material and therefore have a negative effect upon the reset properties of the press pad. This interferes with the desired force distribution function of the press pad over the respective product to be pressed. Additionally the additives reduce service life, this means the number of the possible press cycles of the press pad.

The utility model DE 20 2007 019 506 U1 describes a press pad that includes a fabric including warp threads and weft threads. Thus, the warp threads are formed from a plurality of individual threads that run parallel to each other and that are enveloped by a cladding made from an elastomer material wherein the weft threads are also formed from a plurality of metal threads that run parallel to each other. The press pad is characterized by improved elasticity and pressure balancing capability. In particular it can also be provided that the threads included in the warp threads are loosely arranged in the elastomer material, in particular without being coiled into a rope.

### BRIEF SUMMARY OF THE INVENTION

Thus, it is an object of the invention to propose an alternative press pad which complies with current requirements with respect to fast heat transfer and strong reset properties.

The object is achieved by A press pad for a single level or multi-level hot press, the press pad including a fabric made from two intersecting thread systems, wherein threads of a first thread system are respectively formed by a core thread and a cladding, wherein the cladding is made from an elastomer material and threads of a second thread system respectively include metal or are made from metal, wherein threads of the second thread system run in an alternating pattern over and under a group of adjacent threads of the first thread system wherein the group includes at least two directly adjacent and parallel threads, wherein groups that are separated from each other by at least one thread of the first thread system run on congruent paths or on paths that are displaced relative to each other in a thread longitudinal direction, and wherein the at least two directly adjacent and parallel threads of the each of the groups are respectively movable relative to each other.

A group according to the instant application is a combination of at least two threads wherein the threads essentially extend on an identical path over their entire length in the fabric.

“Identical path” according to the instant invention is a path of the threads where the threads essentially cannot be told apart viewed in a direction of a fabric plane. In particular sectional rises and/or depressions of the coinciding threads that are caused by binding the threads by threads of the other thread system are essentially identical relative to a center plane of the fabric.

Movable relative to each other according to the instant application means that the threads are respectively movable at least in a direction that is transversal to a thread longitudinal direction. The threads included in a group are provided in particular in a form of individual threads, wherein each of the threads has a proper cladding made from an elastomer material.

The press pad according to the invention has many advantages. In particular the relative movability of the threads of a group relative to each other facilitates that the fabric is flexible overall. Simultaneously an increased running length of the threads of the second thread system at the surface of the press pad is created which causes an increased contact surface with a heating plate or a press plate and thus increased heat conductivity. The increased running length of the threads is thus caused by the path of the threads of the second thread system above and below the group that is made from the threads of the first thread system. Thus, the running length is determined as a function of threads included in the group

The threads of the first thread system that are included in a group can be advantageously configured as non-twisted double threads or triple threads wherein the threads included in a group can respectively include a cladding made from an elastomer material so that the threads are respectively movable relative to each other.

An advantageous embodiment of the invention provides that the groups that run on identical paths or that are shifted relative to each other in the thread longitudinal direction are separated from each other by another group. For example, it is conceivable that the groups made from three threads are separated from each other by a group that is made from two threads. The threads of the second threads system that include metal or that are made from metal therefore run in an alternating pattern above and below three or two threads of the first thread system.

According to an advantageous embodiment of the invention, it is provided that the threads of the second thread system run in a group, the group made from at least two directly adjacent threads that are movable relative to each other and that run parallel to each other in an alternating pattern above and below a group of adjacent threads of the first thread system. Since the threads of the second thread system contribute substantially to a transfer of heat into the press blank, heat transfer can be significantly improved this way. Thus, it is conceivable that the threads of the second thread system extend in pairs above and below the groups of adjacent threads of the first thread system.

An advantageous embodiment of the invention provides that the fabric has a Panama weave. In the Panama weave groups of the first thread system run in an alternating pattern above and below groups of the second thread system, wherein groups that are separated from each other by a group run on congruent paths. The number of threads that are included in the first and the second thread system is identical in the Panama weave. Consequently, the visible surface of the fabric forms a checkerboard pattern.

The arrangement of plural metal threads adjacent to each other is advantageous in particular with respect to increasing a contact surface with the heating plate or the press plate. Thus, heat can the transported very well from one thread to a respectively adjacent thread by the threads that are arranged adjacent to each other and can be subsequently transferred to the press plate. A cushioning effect of the elastomer thread itself is thus not restricted at all or at least not significantly restricted.

Thus, an advantageous embodiment provides that the fabric has a rib weave, advantageously a transversal rib weave or a longitudinal rib weave. In a rib weave threads of a thread system respectively run as a group in an alternating pattern above or below groups of the other thread system, wherein a number of threads respectively included in the respective groups differs from each other. By the same token groups that are separated from each other by a group run on congruent paths.

Transversal rib weave and longitudinal rib weave differ in that a number of threads in the groups formed by the warp threads exceeds a number of threads in the groups formed by the weft threads in the transversal rib weave. In the longitudinal rib weave this constellation is provided in an inverted arrangement. Thus, it is conceivable that the warp threads run individually in an alternating pattern above and below a group made from four weft threads in the transversal rib weave. This generates a transversal ribbed surface structure of the fabric. In longitudinal rib weave it is conceivable that the warp threads run in a group of two threads in an alternating pattern above and below individual weft threads. This creates a longitudinally running ribbed surface structure of the fabric.

Advantageously a number of warp threads can be increased in transversal rib weave so that the weft threads disappear thereunder completely. With respect to the heat conductivity of the press pad this embodiment is particularly advantageous since the weft threads which are advantageously formed by a core thread and a cladding are formed from an elastomer material primarily contribute to the cushioning effect of the press pad, whereas the heat transfer is primarily formed by the metal threads of the second thread system.

The threads of the first thread system are formed by a core thread and a cladding made from an elastomer material. Elastomer materials like silicone rubber, fluor rubber and co polymers made from silicone rubber and fluor silicone rubber have proven suitable for high temperature applications up to 250 degrees C. Other elastomer materials that are stable in this temperature range can also be used. An elastomer thread of this type is particularly well suited for an application in single or multi-level hot presses that operate at temperatures of more than 250 degrees C.

Another advantageous embodiment of the invention provides that the fabric has a twill weave. In the twill weave groups of the first thread system that are separated from each other by at least one thread and made from threads of the first thread system are displace relative to each other in thread longitudinal direction. This way a slanted ridge is created. It is also conceivable that also the threads of the second thread system run in a group including at least two threads so that a double twill weave is created.

According to an advantageous embodiment the core threads of the first thread system are formed from a metal. The elastomer material threads are produced in an extruder, wherein the elastomer material threads are provided with a core thread to provide stabilization. This creates high tensile load bearing capability of the combination threads without impairing cushioning properties. However, it is also conceivable that the core threads are made from different metal threads or other high temperature resistant materials. In the extruder the elastomer material is formed about the core thread that is subsequently run into a drying zone for cross linking. The drying zone can include infra-red radiation, hot air or an overheated salt bath.

Advantageously the threads of the second thread system include brass wire or are made in their entirety from brass wire, in particular brass wire strands. Brass is particularly well suited due to its heat conducting properties. Advantageously also the threads of the second thread system are formed e.g., from copper, bronze, aluminum or steel. Other metals can be used as well as required. The fabric can also include different metal threads as required in order to accommodate a spatial heat distribution within the press arrangement. For the weaving process of a metal fabric, it is advantageous to use stranded metal threads for the weft and/or warp threads. Thus, several individual fine metal threads configured as a stranded metal threads can be introduced into the fabric in order to additionally improve heat conduction.

When there is an uneven heat distribution at the press plant the uneven heat distribution can be considered already during the fabric production corresponding to the heat distribution pattern. The warp threads are then formed from metal threads with different heat transfer constants. The heat distribution zones of the hot plates of the respective press plant are thus measured in advance by thermo couples or by a thermal image camera. Thereafter a temperature distribution pattern is drawn and the respective zones are transferred to the poster size. According to this pattern the metals of the warp threads can be subsequently determined and the zones can be imaged in the fabric.

According to an advantageous embodiment of the invention the fabric is provided in one layer. This way it is assured that the metal threads conduct heat absorbed at the top side directly to the bottom side of the press pad. In particular no air inclusions are generated by the one-layer configuration of the fabric wherein the air inclusions would act as thermal insulators that inhibit a transfer of the absorbed heat to the bottom side of the press pad.

In an advantageous embodiment of the invention it is provided that the fabric is symmetrical with respect to a center plane that runs parallel to a surface of the press pad. Advantageously the contact surface to receive the heat at the heating plate thus corresponds to the contact surface that transfers the heat to the press plate. Thus, a complete transfer of the received thermal energy to the bottom side of the press pad that is in contact with the press plate can be provided. This helps to prevent an undesirable heat accumulation within the press pad.

According to an advantageous embodiment the threads of at least one thread system have a circular cross section. With respect to the cushioning effect of the press pad configuring circular cross sections can be particularly advantageous since the threads cause a symmetrical cushioning of impacting forces. Forming a circular cross section of threads forming the group furthermore has the effect that only the threads that run in an alternating pattern above and below the group on both side surfaces of the press pad come in contact with the heating plate or the press plate. Advantageously a cross section of the threads that runs in an alternating pattern above and below the group is considered flat so that the cross section can be brought in contact with the respective surface quite well.

### BRIEF DESCRIPTION OF THE DRAWINGS

The invention is now described based on two advantageous embodiments with reference to drawing figures, wherein:

FIG. 1 illustrates a top view of a first press pad according to the invention with crossing warp threads and weft threads;

FIG. 2 illustrates a cross sectional view of the press pad illustrated in FIG. 1;

FIG. 3 illustrates the weave cartridge of the press pad according to FIG. 1;

FIG. 4 illustrates a top view of a second press pad according to the invention;

FIG. 5 illustrates a cross sectional view of the press pad illustrated in FIG. 4; and

FIG. 6 illustrates the weave cartridge of the press pad according to FIG. 4.

### DETAILED DESCRIPTION OF THE INVENTION

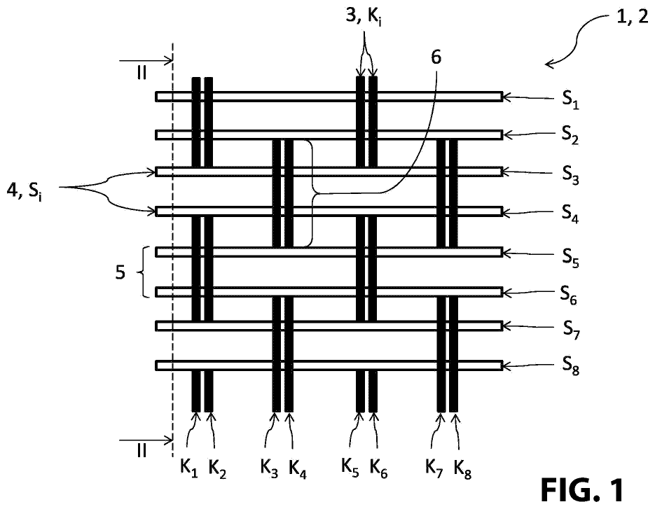

FIG. 1 illustrates a surface of a first press pad 1 according to the invention. The press pad 1 is made from two crossing thread systems 3, 4 that form a fabric 2. In the instant embodiment both thread systems 3, 4 in the illustrated fabric section respectively include eight threads K₁ through K₈ and S₁ through S₈. Thus, the eight threads K₁ through K₈ of the first thread system 3 are made from stranded brass threads and form the warp threads Kᵢ of the fabric 2. The eight threads S₁ through S₈ of the second thread system 4 form the weft threads Sᵢ of the fabric 2 and are respectively made from a core thread which is respectively formed from stranded individual metal threads and a cladding made from elastomer material.

The fabric 2 has a Panama weave. That means that the threads K₁ through K₈ of the first thread system 3 run in pairs in an alternating pattern above and below a group 5 consisting of two threads Sᵢ of the second thread system 4. The individual threads Sᵢ of the respective groups 5 and the binding warp threads Kᵢ thus run parallel to each other and are arranged directly adjacent to each other. The threads Sᵢ of the second thread system 4 that are included in a group are movable relative to each other. Groups 5 of the first thread system 3 that run on congruent paths are thus separated from each other by a group 5. The warp threads Kᵢ are shown offset from each other in FIG. 1 for purposes of clarity. Advantageously the warp threads Kᵢ that bind in pairs are in direct contact with each other so that a heat transfer can be performed to the respective adjacent thread Kᵢ. Since the metal warp threads Kᵢ always run above and below two respective weft threads S₁ an extended running length 6 of the metal threads Kᵢ is generated at the surface of the press pad 1, wherein the extended running length leads to an increased contact surface with the heating plate or the press plate and thus to increased heat conductivity.

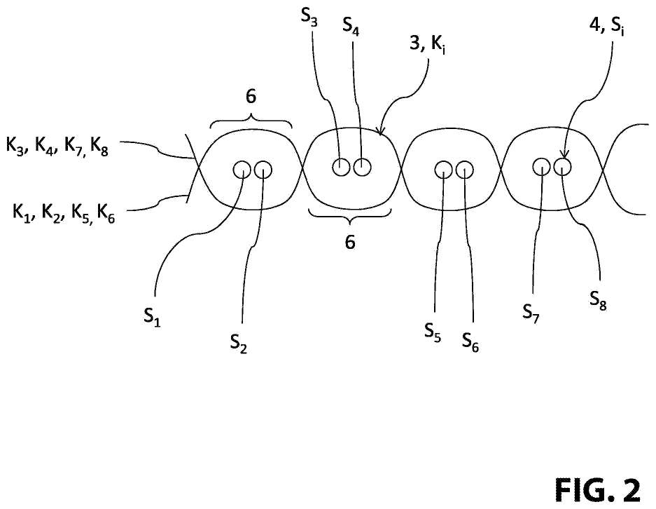

FIG. 2 illustrates a cross section through the press pad 1 illustrated in FIG. 1 along the sectional line II in FIG. 1. This illustration emphasizes the float of the warp thread K over two respective weft threads Sᵢ. Thus, two respective directly adjacent warp threads Kᵢ run on congruent paths. In the instant case this means that the first two warp threads K₁ and K₂ run above a group 5 consisting of the first weft thread S₁ and the second weft thread S₂ in the beginning and subsequently run below a group 5 consisting of the third weft thread S₃ and the fourth weft thread S₄. The third warp thread K₃ and the fourth warp thread K₄ and the seventh warp thread K₇ and the eighth warp thread K₈ run exactly in opposite directions. Put differently, the warp threads Kᵢ recited supra start above the first group 5 and then run below the second group 5 of the weft threads Sᵢ. The weave recited supra continues analogously over the entire fabric 2.

As evident from FIG. 2 the weave after two respective weft threads Sᵢ yields an extended running length 6 of the warp threads Kᵢ at the top side and the bottom side of the fabric 2 compared to a weave after each weft thread Sᵢ. This yields in particular an improved heat transfer to the heating plate and the press plate. By the same token the fabric 2 remains flexible due to the relative move ability of the weft threads Sᵢ.

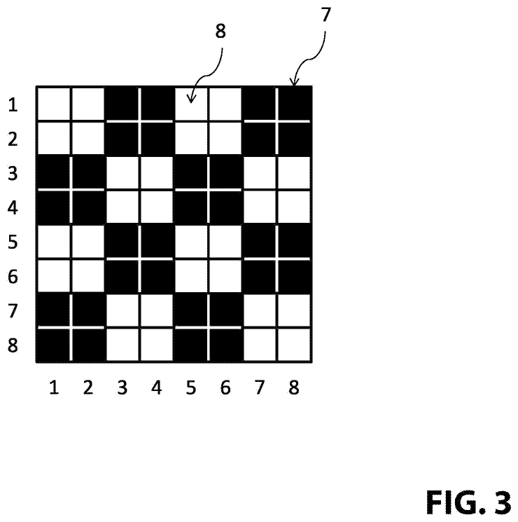

FIG. 3 illustrates the weave cartridge of the press pad 1 of FIG. 1. Thus, the black fields 7 represent warp rises where the warp threads Kᵢ are arranged above the weft threads Sᵢ. Accordingly, the white fields 8 represent warp depressions where the weft threads Sᵢ are arranged above the warp threads Kᵢ. The checker board pattern of the Panama weave is clearly visible.

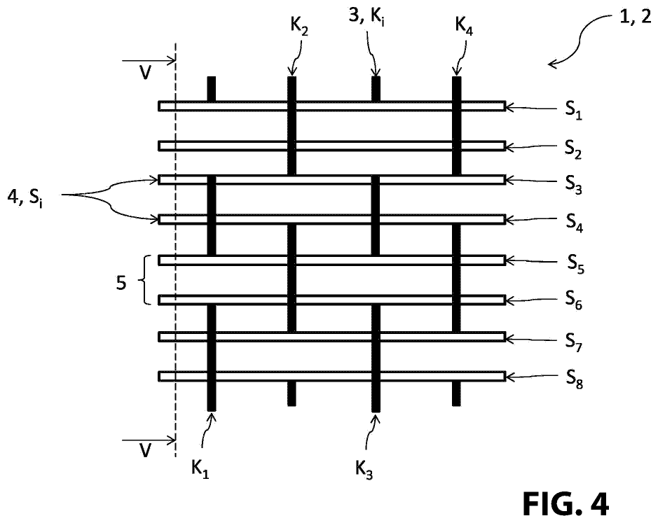

FIG. 4 illustrates a surface of a second press pad 1 according to the invention. The press pad 1 is also made from a fabric 2 formed by two intersecting thread systems 3, 4. In the instant embodiment the first thread system 3 includes four threads K₁-K₄ whereas the second thread system 4 includes eight threads S₁ through S₈. Thus, the four threads K₁ through K₄ of the first thread system 3 are made from stranded brass threads and form the warp threads Kᵢ of the fabric 2. The eight threads S₁ through S₈ of the second thread system 4 are formed by the weft threads Sᵢ of the fabric 2 and are respectively made from a core thread that is also formed from stranded individual metal threads and a cladding made from an elastomer material.

The fabric 2 in FIG. 4 has a transversal rib weave. Contrary to the Panama weave the weft threads Sᵢ are bound only by one warp thread Kᵢ in this weave. This means that the threads K₁ through K₄ of the first thread system 3 run individually in an alternating pattern above and below a group 5 including two threads S₁ of the second thread system 4. The individual threads S₁ of the respective group 5 and the binding warp threads Kᵢ thus run parallel to each other and are arranged directly adjacent to each other.

Also, here an extended running length of the warp threads Kᵢ is created due to the extension of the warp threads Ki above and below two respective weft threads Sᵢ wherein the extended running length also leads to an increased contact surface with the heating plate and the press plate and thus to an increased heat conductivity.

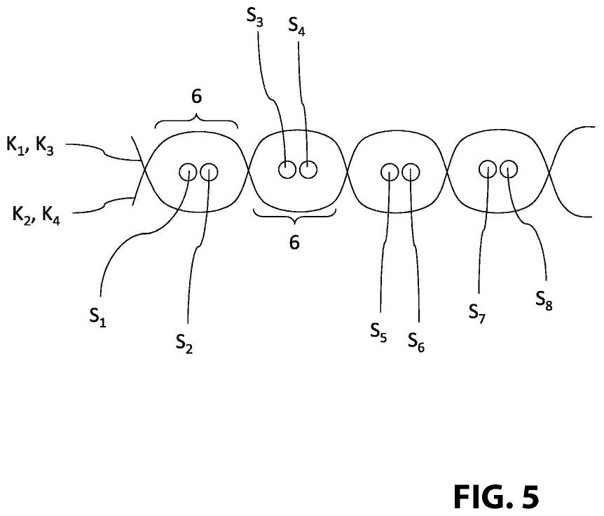

FIG. 5 illustrates a cross section through the press pad 1 illustrated in FIG. 4 along the sectional line V of FIG. 4. It is evident that the warp threads Kᵢ bind respectively after two weft threads Sᵢ. Thus, the warp threads Kᵢ that are respectively separated from each other by a warp thread Kᵢ run on identical paths. In the instant embodiment this means that the first warp thread K₁ initially runs below a group 5 made from the first weft thread S₁ and second weft thread S₂ and subsequently runs above a group 5 made from the third weft thread S₃ and the fourth weft thread S₄. The second warp thread K₂ and the fourth warp thread K₄ run in precisely opposite directions thereto. Put differently these warp threads Kᵢ initially run above the first group 5 and subsequently run below the second group 5. This weave continues analogously over the entire fabric 2.

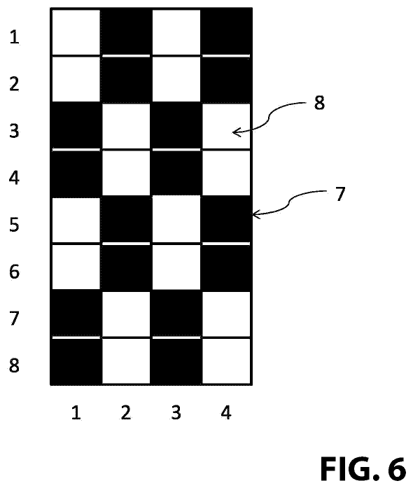

FIG. 6 illustrates a weave cartridge of the press pad 1 of FIG. 4. Thus, the black fields 7 represent warp rises where the warp threads Kᵢ are above the weft threads Sᵢ. Accordingly, the white fields 8 form warp depressions where the weft threads Sᵢ are arranged above the warp threads Kᵢ.

### REFERENCE NUMERALS AND DESIGNATIONS

1 press pad
2 fabric
3 first thread system
4 second thread system
5 group
6 running length
7 black field
8 white field
Kᵢ warp thread
K₁ first warp thread
K₂ second warp thread
K₃ third warp thread
K₄ fourth warp thread
K₅ fifth warp thread
K₆ sixth warp thread
K₇ seventh warp thread
K₈ eighth warp thread
Sᵢ weft thread
S₁ first weft thread
S₂ second weft thread
S₃ third weft thread
S₄ fourth weft thread
S₅ fifth weft thread
S₆ sixth weft thread
S₇ seventh weft thread
S₈ eighth weft thread

What is claimed is:

1. A press pad for a single level or multi-level hot press, the press pad comprising:
a fabric made from two intersecting thread systems,
wherein threads of a first thread system are respectively formed by a core thread and a cladding wherein the cladding is made from an elastomer material and threads of a second thread system respectively include metal or are made from metal,
wherein threads of the second thread system run in an alternating pattern over and under a group of adjacent threads of the first thread system,
wherein the group of the adjacent threads of the first thread system includes at least two directly adjacent and parallel threads,
wherein groups of adjacent threads of the first thread system that are separated from each other by at least one thread of the first thread system run on congruent paths or on paths that are displaced relative to each other in a thread longitudinal direction, and
wherein the at least two directly adjacent and parallel threads of the each of the groups of the adjacent threads of the first thread system are respectively movable relative to each other.

2. The press pad according to claim 1, wherein the groups that run on congruent paths or on paths that are displaced relative to each other in the thread longitudinal direction thread system are separated from each other by a group.

3. The press pad according to claim 1, wherein the threads of the second thread system that run in second groups which respectively include at least two threads that are movable relative to each other and that run parallel to each other in an alternating pattern above and below the group of the adjacent threads of the first thread system.

4. The press pad according to claim 1, wherein the fabric has a Panama weave.

5. The press pad according to claim 1, wherein the fabric has a transversal rib weave or a longitudinal rib weave.

6. The press pad according to claim 1, wherein the fabric has a twill weave.

7. The press pad according to claim 1, wherein the core threads of the first thread system are made from metal.

8. The press pad according to claim 1, wherein the threads of the second thread system include brass wire or are formed in their entirety from brass wire or stranded brass wire.

9. The press pad according to claim 1, wherein the fabric has one layer.

10. The press pad according to claim 1, wherein the fabric is symmetrical with respect to a center plane that runs parallel to a surface of the press pad.

11. The press pad according to claim 1, wherein the threads of the first thread system or the second thread system have a circular cross section.
